(19) United States
(12) Patent Application Publication
(10) Pub. No.: US 2013/0076886 A1
(43) Pub. Date: Mar. 28, 2013

(54) Automatic Focus and Sample Detection

(71) Applicants: Yasunori Ikeno, Santa Clara, CA (US); Maty Moran, Yokneam (IL)

(72) Inventors: Yasunori Ikeno, Santa Clara, CA (US); Maty Moran, Yokneam (IL)

(73) Assignee: Olympus Integrated Technologies America, Inc., San Jose, CA (US)

(21) Appl. No.: 13/460,550

(22) Filed: Apr. 30, 2012

Related U.S. Application Data
(60) Provisional application No. 61/539,898, filed on Sep. 27, 2011.

(51) Int. Cl. H04N 7/18

(52) U.S. Cl. 348/79; 348/E07.085

(57) ABSTRACT

Imaging systems, such as optical microscopes, can benefit from automatic focus enhancements including sample detection. For example, systems that use a charge coupled device (CCD) video camera to capture a field of view for making focus determinations can benefit from automatic focus and sample detection. A method according to certain embodiments can include obtaining, by a machine, a high level image of a sample. The method can also include determining, by the machine, whether a plurality of auto-focus areas of a plurality of fields of view are aligned with a portion of the sample. The method can further include obtaining, by the machine, a low level image of the sample when the plurality of auto-focus areas are aligned.

### CROSS REFERENCE TO RELATED APPLICATIONS

This application is related to, claims the priority of, and incorporates by reference herein the entirety of U.S. Provisional Patent No. 61/539,898, filed Sep. 27, 2011.

### BACKGROUND

1. Field

Imaging systems, such as optical microscopes, can benefit from automatic focus enhancements including sample detection. For example, systems that use a charge coupled device (CCD) video camera to capture a field of view for making focus determinations can benefit from automatic focus and sample detection.

2. Description of the Related Art

Some microscopes include a hardware component that analyzes a charge coupled device (CCD) camera image to measure the sample focus quality. In the CCD camera image, only a portion of the field of view (FOV) is used by the hardware component to measure the focus quality. This is called the Active Focus Area (AFA). The hardware component analyzes the sample in the AFA and adjusts the focus for best image. The CCD camera then captures the focused image for this FOV. However, conventionally it sometimes happens that the sample being observed under the microscope does not fall within the AFA, which can lead to the focus not being appropriate for the sample.

### SUMMARY

A method according to certain embodiments includes obtaining, by a machine, a high level image of a sample. The method also includes determining, by the machine, whether a plurality of auto-focus areas of a plurality of fields of view are aligned with a portion of the sample. The method further includes obtaining, by the machine, a low level image of the sample when the plurality of auto-focus areas are aligned.

In certain embodiments, an apparatus includes a high level image source configured to provide a high level image of a sample. The apparatus also includes a scan position determination section configured to determine whether a plurality of auto-focus areas of a plurality of fields of view are aligned with a portion of the sample. The apparatus further includes an image capture section configured to obtain a low level image of the sample when the plurality of auto-focus areas are aligned.

An apparatus, in certain embodiments, includes high level means for obtaining a high level image of a sample. The apparatus also includes determining means for determining whether a plurality of auto-focus areas of a plurality of fields of view are aligned with a portion of the sample. The apparatus further includes low level means for obtaining a low level image of the sample when the plurality of auto-focus areas are aligned.

### BRIEF DESCRIPTION OF THE DRAWINGS

For proper understanding of the invention, reference should be made to the accompanying drawings, wherein:

FIG. 1 illustrates an active focus area with respect to a field of view.

FIG. 2 illustrates a sample on a glass slide with multiple fields of view as seen by a charge coupled device camera.

FIG. 3 illustrates a slide and detail of the slide image.

FIG. 4 illustrates horizontal and vertical shifts according to certain embodiments.

FIG. 5 illustrates two shifts according to certain embodiments.

FIG. 6 illustrates two shifts with incomplete coverage according to certain embodiments.

FIG. 7 illustrates an image composed from a shifted and unshifted image according to certain embodiments.

FIG. 8 illustrates a method according to certain embodiments.

FIGS. 9A, 9B, 9C, and 9D illustrate another method according to certain embodiments.

FIG. 10 illustrates a method of comparison according to certain embodiments.

FIGS. 11A, 11B, and 11C illustrate a method according to certain embodiments.

FIG. 12 illustrates a method of normalization according to certain embodiments.

FIG. 13 illustrates an imaging system according to certain embodiments.

FIG. 14 illustrates another imaging system according to certain embodiments.

### DETAILED DESCRIPTION

Imaging devices, such as optical microscopes, can use a charge coupled device (CCD) based video camera to acquire an electronic image of, for example, a sample under observation. Although this discussion uses a CCD camera as an example of a type of camera that can be used, other camera types can also be used in connection with certain embodiments.

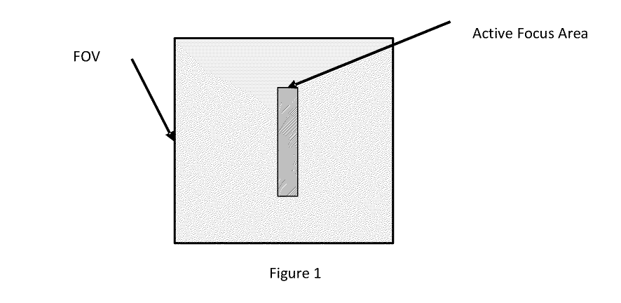

As shown in FIG. 1, the portion of the sample captured in the image can be referred the field of view (FOV). Analysis or measurement of the sample image can permit a decision on whether the sample is in focus or not. The optical components of the microscope can motorized to control the objective position of the microscope. Using the focus measurement information, the objective position can be automatically adjusted to optimize the focus on the sample. This process can be referred to as automatic focus.

The microscope can include a particular hardware component that analyzes the CCD camera image to measure the sample focus quality. In the CCD camera image, only a portion of the FOV is used by the hardware component to measure the focus quality. This are that is used to measure the focus quality can be referred to as the active focus area (AFA). The hardware component can analyze the sample in the AFA and then adjust the focus to produce an image with an appropriate focus. The CCD camera can then capture the focused image for this FOV. As noted above, however, if the sample being observed under the microscope does not fall within the AFA, the focus measurement can be inappropriate for the sample, resulting in an out of focus image being acquired for that FOV.

In FIG. 1, the outer rectangle represents one FOV from a CCD camera point of view. The smaller rectangle in the center represents the active focus area (AFA). In this discussion rectangular shapes are used for purpose of illustration. It is not necessary that the shapes of the FOV or AFA be rectangular.

Samples can be mounted on glass slides in order to be observed and imaged under a microscope. When the sample being observed under the microscope is larger than a single FOV, then multiple images, namely multiple FOVs, can be acquired and combined in order to obtain a single microscopic image of the entire sample.

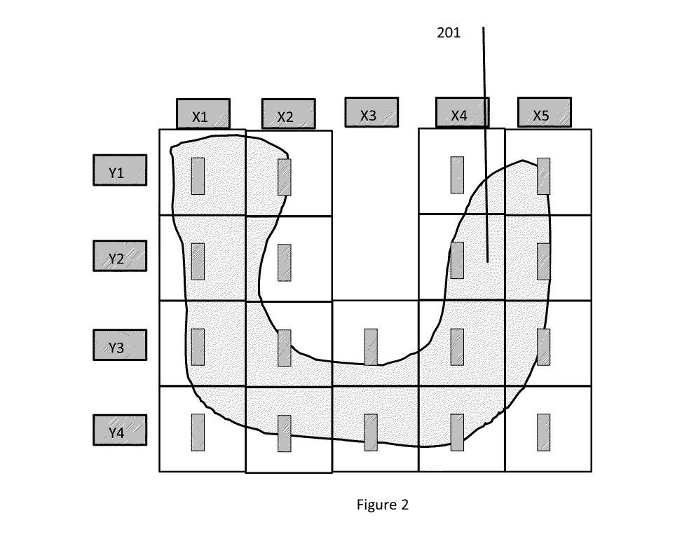

FIG. 2 illustrates a sample on a glass slide with multiple fields of view as seen by the charge coupled device camera. As shown in FIG. 2, the entire area of the slide can be divided logically into columns X1 through X5 and into rows Y1 through Y4. This number of columns and rows is simply for purpose of illustration and is not limiting. Item 201 in FIG. 2 represents a sample for scanning. Here, the sample happens to be U-shaped, but the sample can have any shape. The square at (X1,Y1) can be a single FOV. To cover the whole area of sample 201, multiple FOVs may be required. For example, as shown, eighteen fields of view may be used.

In some fields of view, the sample may exist in the AFA. However, in the fields of view at (X2, Y2), (X4, Y1), (X3, Y3), (X1, Y4), and (X5, Y4) the sample make not exist within the AFA, even though the sample exists within the field of view.

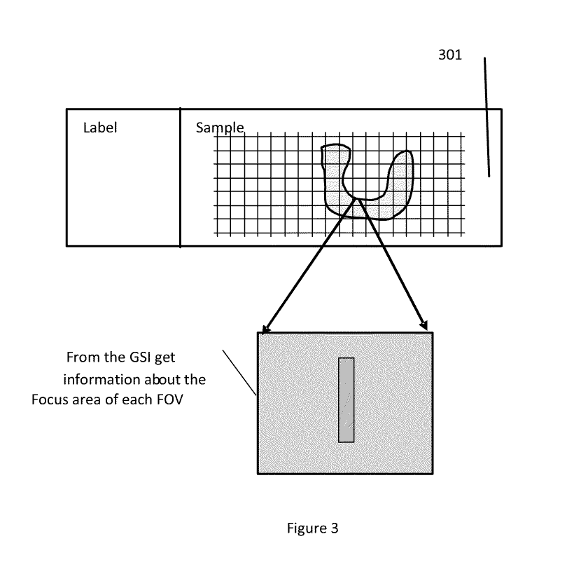

FIG. 3 illustrates a slide and detail of the slide image. As shown in FIG. 3, a very low magnification image of the sample on the full glass slide 301 can be referred to as a glass slide image (GSI). In certain embodiments, this GSI can serve as the basis for checking whether each FOV at higher magnification will have at least part of the sample in the AFA. One reason for making this check may be in order to achieve focus measurement. If, for example, the site does not have a portion of the sample in the AFA but does have a portion of the sample in the FOV but outside the AFA, then the FOV is shifted in one direction (up, down, left, right) in order to put the sample portion in the AFA. It is possible to shift the field of view in more than one direction, but one direction may be enough in certain embodiments.

The shift unit can be defined by an absolute amount or by, for example, the percentage of the shifted site area that is not part of the original site. Thus, in certain embodiments, values can be in a range from about 10% to about 90%.

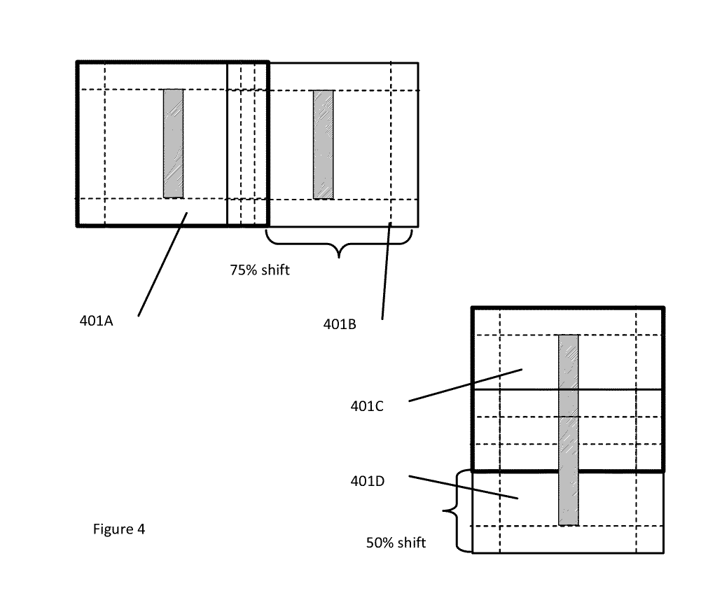

FIG. 4 illustrates horizontal and vertical shifts according to certain embodiments. In FIG. 4, FOV 401B is shown shifted by 75% to the right of FOV 401A to form FOV 401B. As a result only 25% of the left side of FOV 401B may be used to compose FOV 401A. In other words, only the 25% of the left side of FOV 401B may ultimately be used in creating a final image or set of images.

Likewise, in FIG. 4 FOV 401D is shown shifted by 50% down from FOV 401C and as a result only 50% of the upper end of FOV 401D may be used to compose FOV 401C.

As noted above, in FIG. 2, in FOVs (X2,Y2), (X4,Y1), (X3,Y3), (X1,Y4) and (X5,Y4) the AFA does not occur on a portion of the sample. Thus, in those cases there is no sample image on which to measure the focus position. This can result in an out of focus image for the FOV including the portion of the sample that does occur in this FOV.

The amount of shift of images can be determined based on a dynamic analysis of the data. The implementation can calculate a best focus position in the site surrounding the original FOV and then can make the decision on the shift.

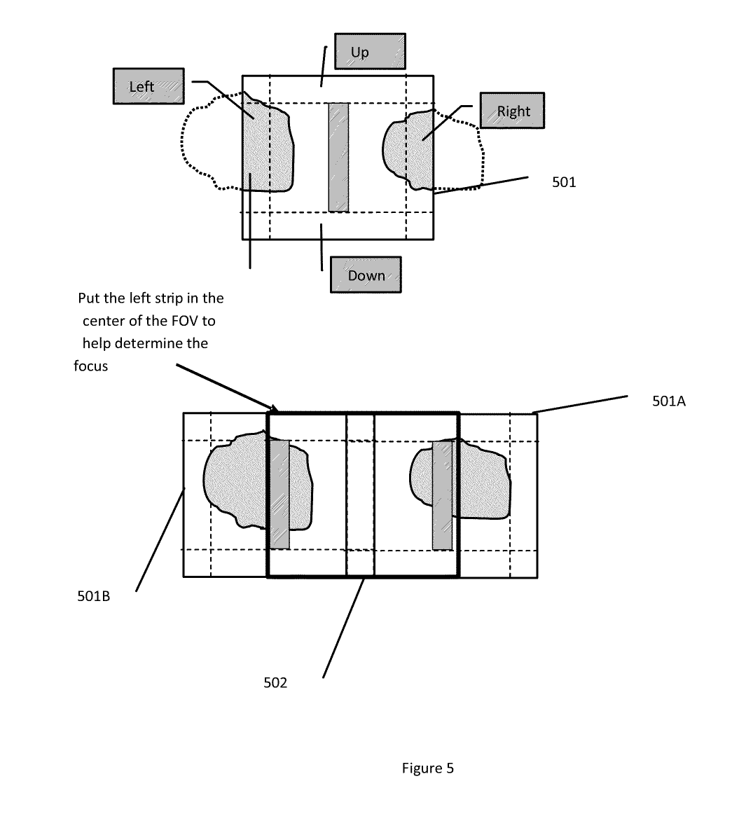

Due to the complexity of the sample, there may be multiple combinations based on shift sizes. FIG. 5 illustrates two shifts according to certain embodiments. In FIG. 5, FOV 501 has an AFA that is not positioned above the sample. In order to improve the focus, the system can take two FOVs 501A and 501B. FOV 501B and FOV 501A, as shown, are each shifted by 50% in opposite directions, so the AFAs have the sample and the focus can be determined accurately. The output from the two FOVs can be a composite image 502 that has the same size as 501 and has been generated by information from 501A and 501B.

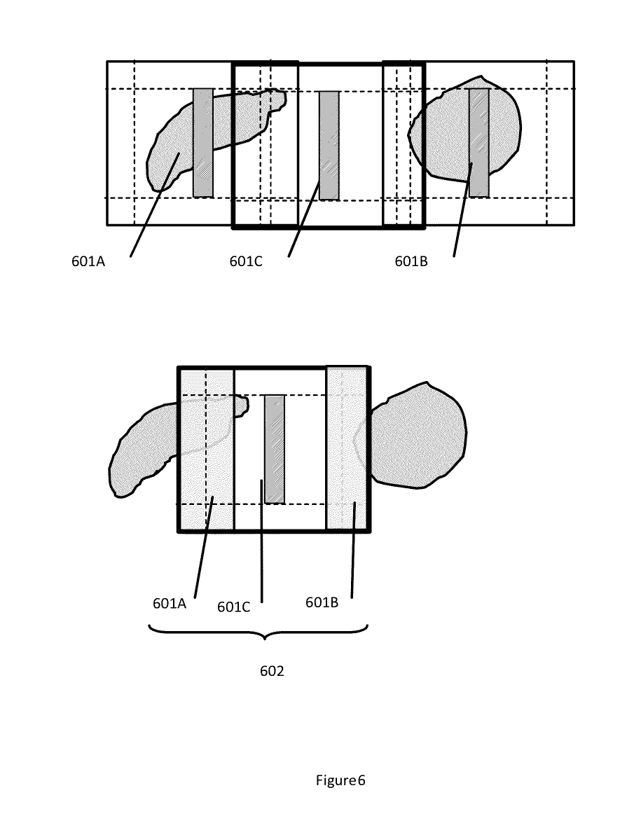

FIG. 6 illustrates two shifts with incomplete coverage according to certain embodiments. In FIG. 6, the shift size is greater than 50% in both directions, providing images 601A, on left, and 601B, on right. However, a central portion of the image, at 601C, may still be needed in order to cover the whole original site area. The system can take three images 601A, 601C, and 601B, from left to right, and compose a target image 602 from them.

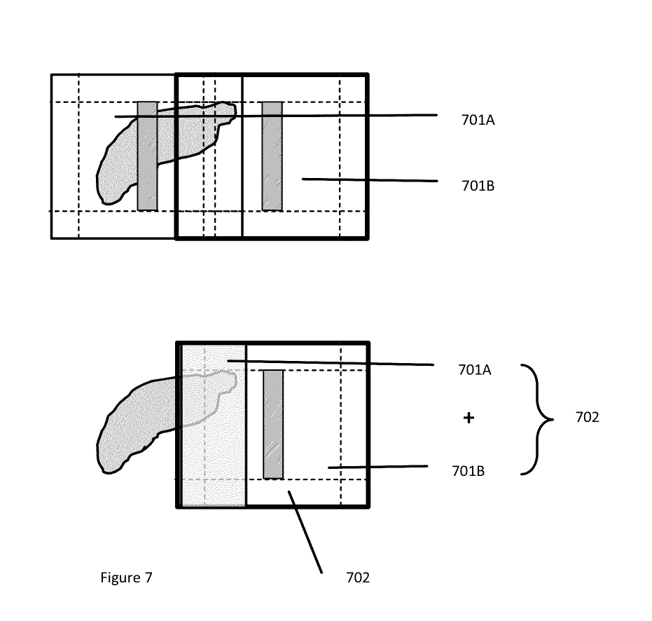

FIG. 7 illustrates an image composed from a shifted and unshifted image according to certain embodiments. In FIG. 7, the image has sample present only on the left side. Thus, the image can be shifted only to left side for better focus. The system can take two FOVs 701A and 701B. FOV 701A is shown shifted by 70% so the AFA has the sample within it, and the focus can be successful. FOV 701B is an unshifted original field of view. The output from the two FOVs can be a composed image 702. In the area of overlap, preference can be given to the shifted image, because the system may assume that the shifted image has a more appropriate focus.

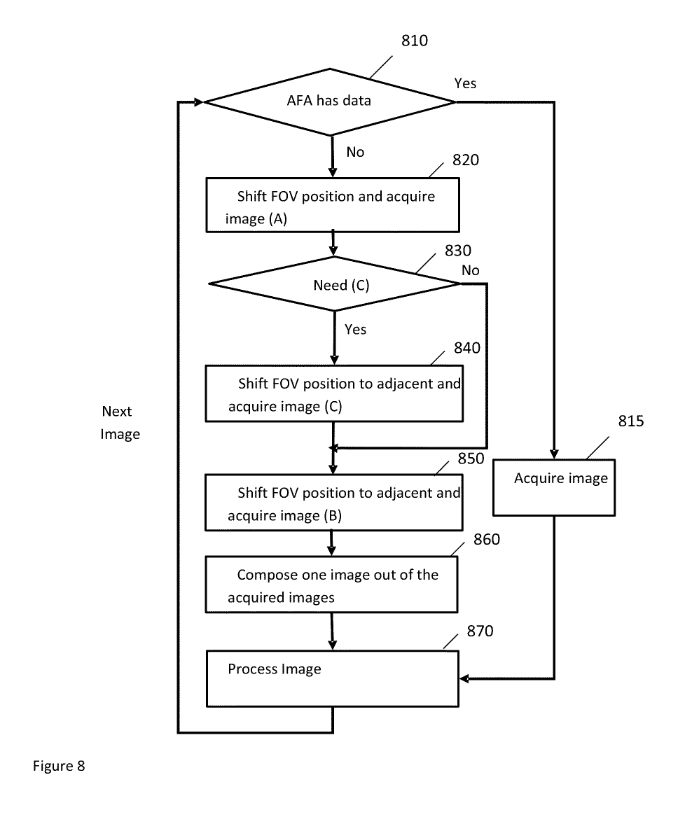

FIG. 8 illustrates a method according to certain embodiments. As shown in FIG. 8, at 810, the system can determine whether the AFA has data. If so, at 815, the system can acquire the image, and then process the image at 870, before proceeding to the next image, or while proceeding to the next image. For each FOV where the AFA is not positioned above the sample, the system can determine to shift the FOV position and acquire image (A) at 820. The system can determine the amount of shift determined by the dynamic analysis of the GSI. The implementation can calculate the best focus position(s) in the surrounding sites and then makes a decision on the shifts. For example, at 830 the system can determine whether a third shifted image (C) is needed. If not, then the system can proceed to 850 to shift and capture an image that may be an “unshifted” image (B) or a shifted image (B). If a third image is needed, the system can proceed to 840 to shift and capture an image (C) and then proceed to 850 to shift and capture another image (B). After that, the system can, at 860, compose one image out of the acquired images, and proceed to process the image at 870, as described above.

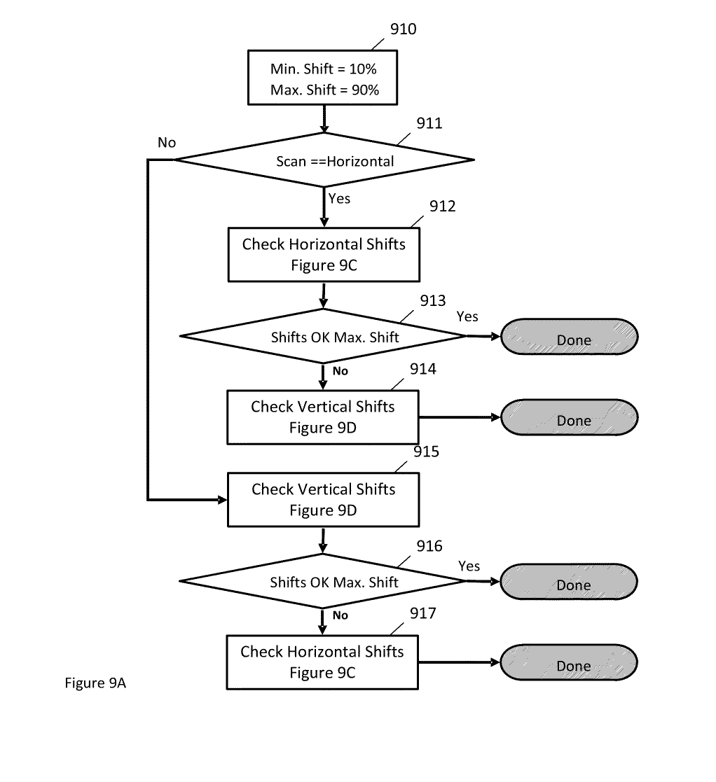

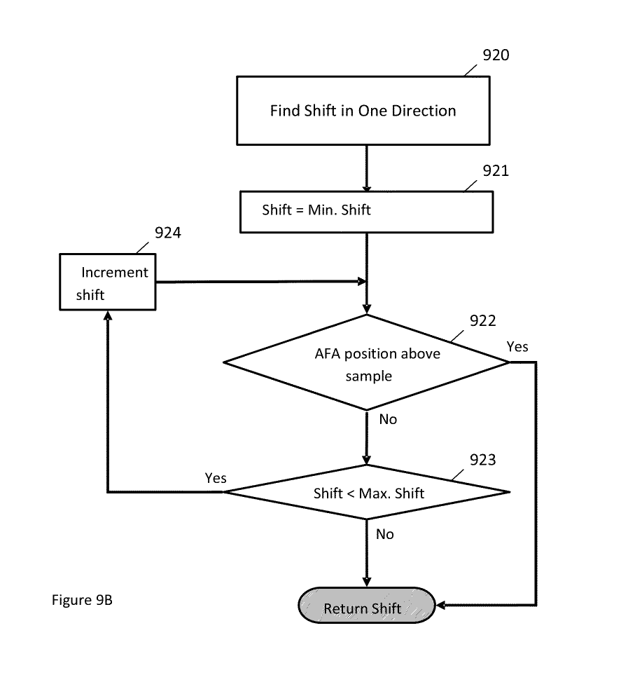

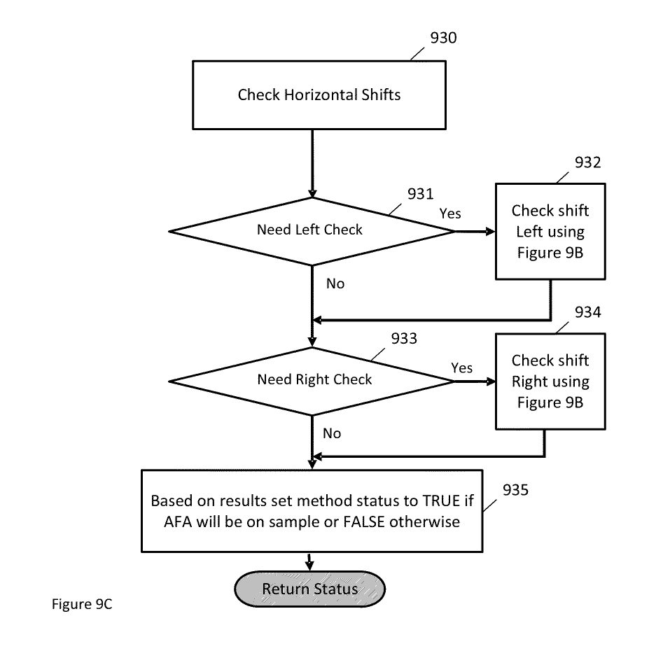

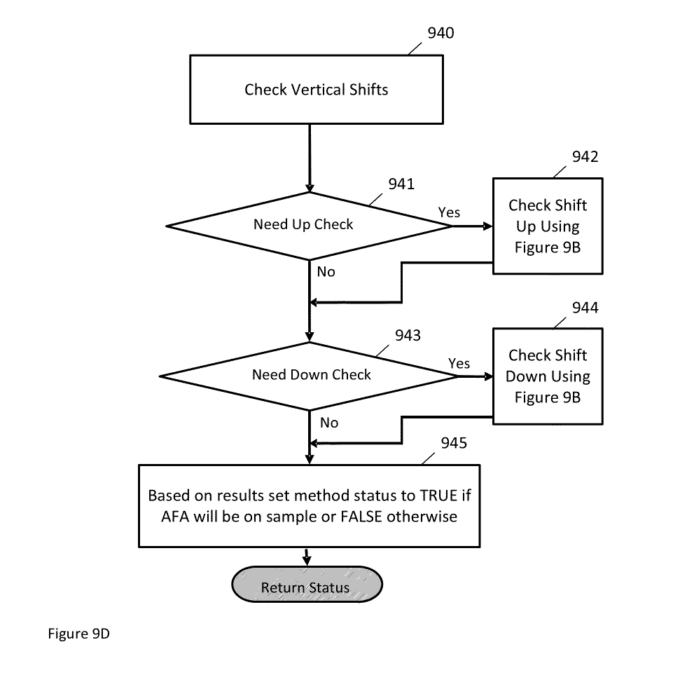

FIGS. 9A, 9B, 9C, and 9D illustrate another method according to certain embodiments. As shown in FIG. 9A, at 910, minimum (Min.) and maximum (Max.) shift values can be configured. In this case, the values are 10% and 90%. Then, at 911, the system can determine whether the imaging system is set up for horizontal scanning as the primary motion direction. If so, then at 912, the system can check horizontal shifts, as will be discussed below at FIG. 9C. Then, at 913, the system can check to see whether the shifts are ok with respect to the maximum shift value. If so, the process can be done. If not, then the system can check vertical shifts, as will be discussed below at FIG. 9D, and can then complete.

If horizontal scanning is not the primary scanning direction, then the system can begin by checking vertical shifts at 915. The system can then check whether the shifts are within the maximum permitted shift values at 916, and terminate if they are. Otherwise, the system can check horizontal shifts and then be done.

As shown FIG. 9B, a method can be called for finding a shift in one direction at 920. The method can include, at 921, initializing the shift at a minimum Then, at 922, the system can determine whether the AFA position is above a sample. If so, the shift can be return to the method that called for it. Otherwise, the system can check whether the shift is less than the maximum shift at 923, and can increment the shift at 924, if it is. Otherwise, the method can return the shift. The shift being returned can be returned with an indication that the shift was unsuccessful.

As shown FIG. 9C, a method can be called for checking horizontal shifts at 930. First, at 931, the system can determine whether a left check is needed. If so, the system can check shift left using FIG. 9B at 932. Whether or not the left shift has been checked, the system can determine at 933 whether a right shift should be checked. If so, at 934 the system can check shift right using FIG. 9B. Whether or not the right shift has been checked, at 935, the system can, based on the results of whatever checking has been performed, set the method status to TRUE if AFA will be on the sample or FALSE otherwise, and return the status to the method that called for it.

As shown FIG. 9D, a method can be called for checking vertical shifts at 940. First, at 941, the system can determine whether an up check is needed. If so, the system can check shift up using FIG. 9B at 942. Whether or not the up shift has been checked, the system can determine at 943 whether a down shift should be checked. If so, at 944 the system can check shift down using FIG. 9B. Whether or not the down shift has been checked, at 945, the system can, based on the results of whatever checking has been performed, set the method status to TRUE if AFA will be on the sample or FALSE otherwise, and return the status to the method that called for it.

Thus, in view of the above, certain embodiments can use information from a relatively low resolution image or GSI, which may be referred to as a high level image, to extract focus information for each FOV at a higher magnification, which may be referred to as a low level image. Certain embodiments can also make the scanning sites position based on the focus applicability. Moreover, certain embodiments compose one image from two or more captured images and can improve image quality.

In the above virtual microscopy, one of the initial steps can be to obtain a digital representation of the slide, the low resolution image, which also referred to as the high level image, because it may provide a broad overview. By analyzing the low resolution image, the system can identify regions of interest on the slide. Those regions of interest on the slide can be the area on the slide where a sample is present. In this discussion, the sample can refer to a biological sample, such as a tissue sample, but could also be another kind of sample, such as microprocessor chip. The regions of interest on the slide can enable the tool to scan in high magnification, which can be referred to as a low level image, only areas with sample present, thereby reducing the scanning time and storage resource usage. For example, referring to FIG. 2, the system can determine that 201 is the region of interest, and consequently can permit the tool to avoid scanning at (X3,Y1) and (X3,Y2).

In certain embodiments, a dedicated CCD equipped with appropriate optics can acquire the whole slide area in one image, which can be referred to as the high level image or macro image. In the system setting procedure, a blank slide can be loaded and its image, for example, a high level image, can be stored for later use. While or before scanning, the slide can be loaded to the macro image station and its image can be acquired.

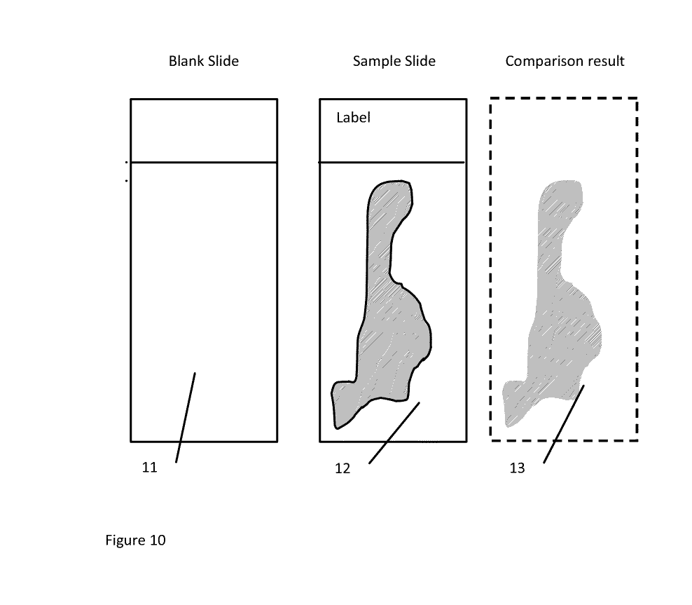

The system can use the comparison between the current slide macro image and the blank slide macro image to detect the sample. FIG. 10 illustrates a method of comparison according to certain embodiments.

As shown in FIG. 10, the high level image of the blank slide 11 and the sample slide 12 can be compared. The result of the compare can be comparison result 12.

A region of interest (ROI) for the detection area can be defined in the system setting. For example, in the illustration shown in FIG. 1, the irregular shaded area may be the region of interest. This region of interest does not have to be irregular in shape. Moreover, the region of interest does not have to correspond to the entire sample. However, in certain embodiments the region of interest corresponds to the area within the boundaries of the sample.

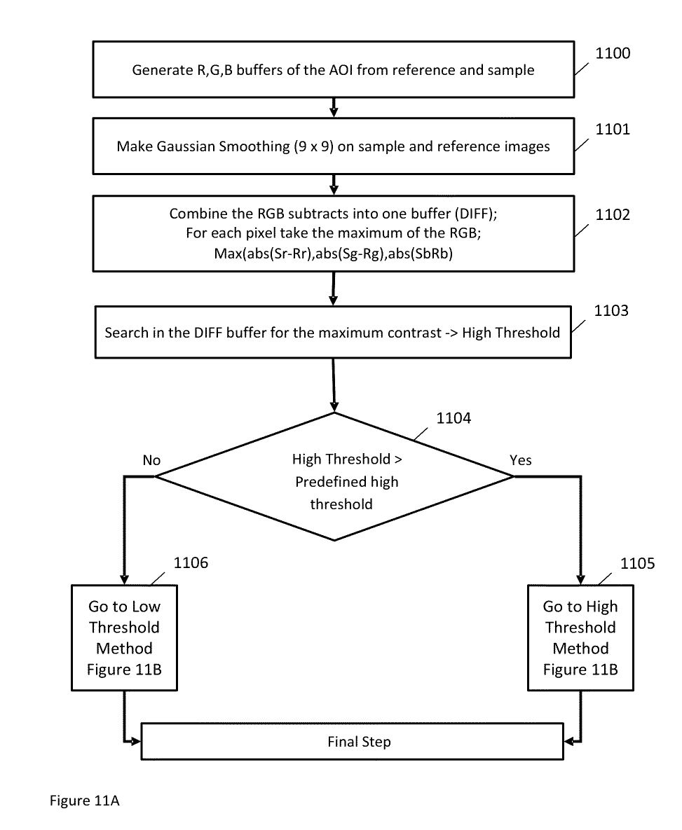

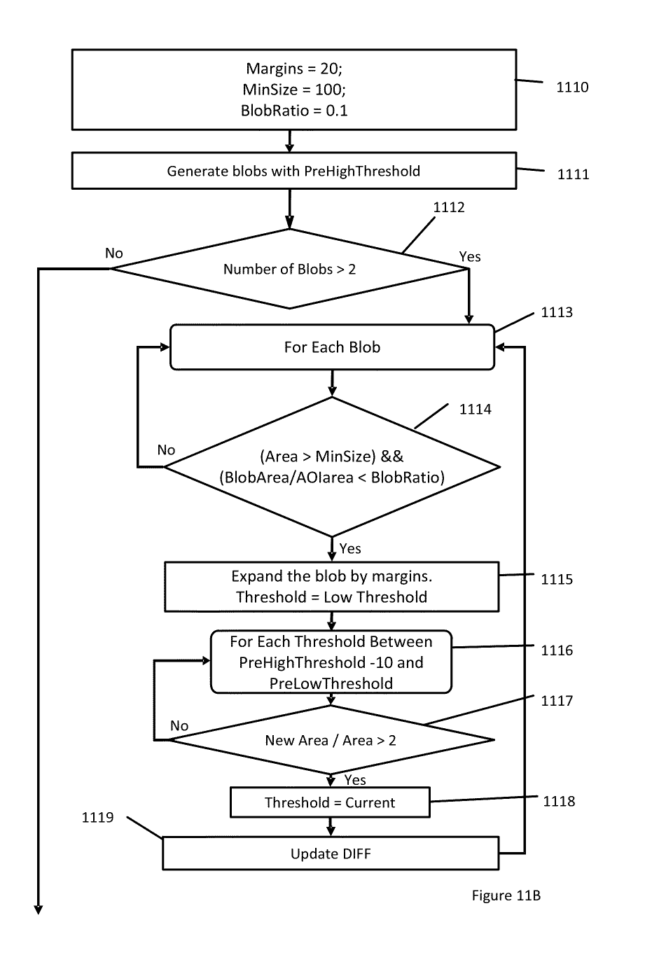

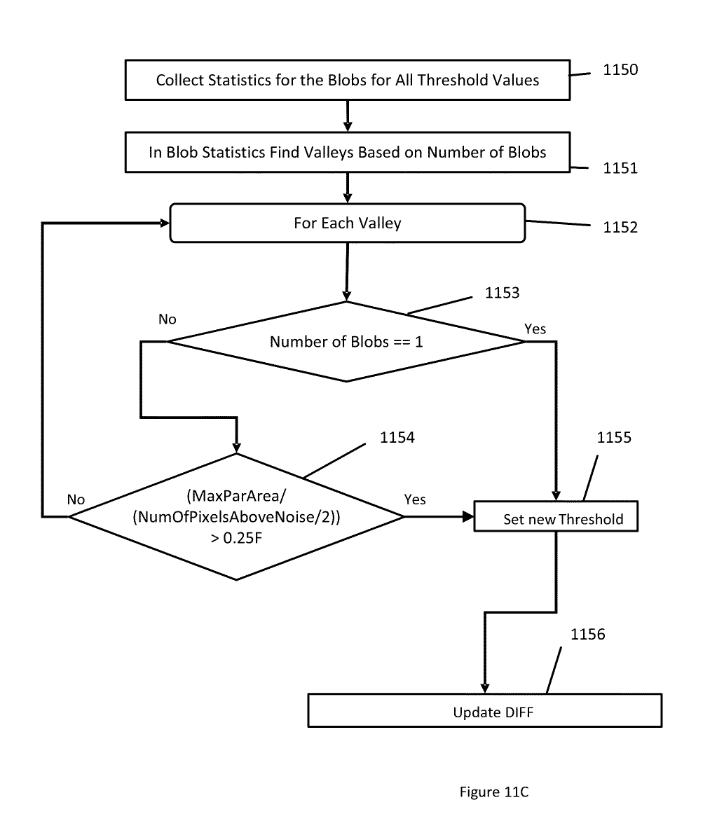

In FIG. 11A, the first step in the detection is to create R,G,B buffers for the blank slide and the sample image, at 1100. To reduce noise, the system can, at 1101, perform Gaussian smoothing with kernel of 9×9.

At 1102, the working detection buffer, DIFF buffer, can be created by performing the following. For each pixel (i,j), the system take the maximum value between the absolute value of: R(i,j) buffer in the sample minus R(i,j) buffer in the blank slide; G(i,j) buffer in the sample minus G(i,j) buffer in the blank slide; and B(i,j) buffer in the sample minus B(i,j) buffer in the blank slide. The system can then write this value into the DIFF buffer.

At 1103, the system can go over the DIFF buffer to find the maximum contrast, which can be referred to as the high threshold.

A high contrast sample can be handled differently from a low contrast sample. At 1104, a DIFF buffer can be sent to a high contrast method, at 1105, or to a low contrast method, at 1106.

FIG. 11B illustrates a high contrast method according to certain embodiments. As show in FIG. 11B, at 1110 definitions can be provided for Margins, the amount of expand of each blob, MinSize, the minimum area for a blob to extend to be considered a blog, and BlobRatio, the ratio between the blob area and the sample area. The margins value in the illustrated example is set to 20, but this is just one example. Likewise the MinSize is 100 and the BlobRatio is 0.1, but these are just example values.

At 1111, a first step can be to generate blobs using the high threshold as defined in the tool configuration. Then, at 1112, if the number of blobs is greater than 2, the system can start to go over, for each blob at 1113, all blobs in the sample to verify if they meet the expand criteria, at 1114.

If a blob meets the expand criteria the system can expand it at 1115, otherwise, the system can move on to the next blob at 1113. For an expanded blog, the system can look for new threshold by examine thresholds, at 1116, and checking whether the threshold is good enough at 1117. Once the threshold is found to be good enough, the current threshold is updated at 1118 and the blob with its new threshold is written into the DIFF buffer at 1119.

FIG. 11C illustrates a low contrast method according to certain embodiments. As show in FIG. 11C, a first step can be, at 1150, to create statistics about the blobs count in each of the thresholds using all thresholds domain. Next, at 1151, all the valleys can be found based on a number of blobs distribution.

Then, for each valley, at 1152, the system can check whether the number of blobs is equal to one, at 1153. If equal to one the assumption by the system can be that this threshold will give a good detection for this slide, the system can set this valley position as a threshold, at 1155, and can update the DIFF buffer at 1156. Otherwise, at 1154, if the Maximum Area of the blobs, divided by half the number of pixels above noise is greater than 0.25, a new threshold is set, at 1155 otherwise the system can continue to the next valley.

In the slide image acquisition, the system can make averaging of N images to improve the signal to noise ratio. N can be a tool configuration parameter. The averaging of N images can be used to provide, in effect, a reference slide that has a more typical experience of noise.

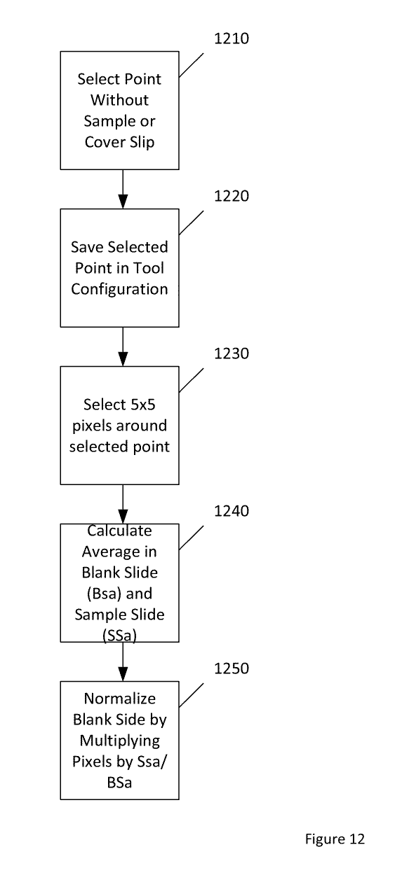

FIG. 12 illustrates a light normalization method according to certain embodiments. A light normalization method can be used to compensate for light source drift over time, as well as for light stability the system. This operation can work on the blank slide to bring it to the current light condition. The normalization can start, at 1210, by selecting a point on the image that cannot have a sample or a cover slip. This point location can then, at 1220, be stored in the tool configuration.

In run time before the sample detection the system can take, at 1230, 5×5 pixels around the selected location and, at 1240, can calculate the average in the Blank slide (BSa) and the sample slide (SSa). The number of pixels can be varied as desired. For example, if desired a 10×10 pixel selection can be used instead. The normalization can be done by multiplying, at 1250, each pixel in the Blank Slide by the factor SSa/BSa.

Certain embodiments, therefore, can provide a delta calculation for comparing sample slide image with blank slide image. Moreover, certain embodiments can provide normalization in between a sample image and a blank image. Certain embodiments can provide for acquiring multiple macro images and doing an averaging for reducing noise. The multiple macro images can be obtained at periodic intervals or around the same time.

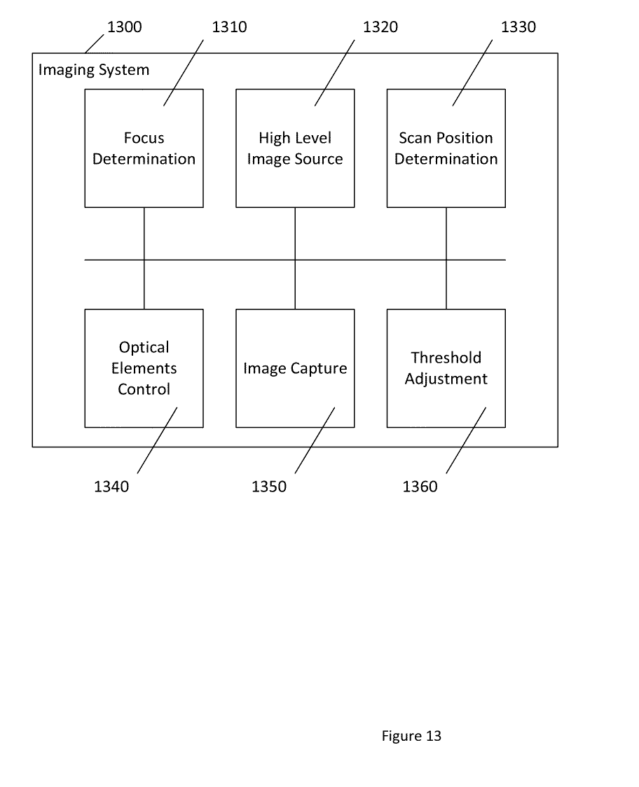

FIG. 13 illustrates an imaging system according to certain embodiments. As shown in FIG. 13, an imaging system 1300 can include a focus determination section 1310, which can be used to determine the appropriate focus of a low level scanner using, for example, optical elements control 1340. The system 1300 can also include a high level image source 1320, which can be either a camera for capturing a high level, low resolution macro image, or can be a memory in which the images from such a camera are stored. The system 1300 can also include a scan position determination section 1330. This section can determine the appropriate position of a scanner with respect to a slide in time.

The system 1300 can also include an image capture section 1350, which can include a low level, high resolution image capture device, such as a CCD camera, or the controls for operating such a device, if the camera is external to the imaging system 1300. The imaging system 1300 can also include a threshold adjustment section 1360. The threshold adjustment section 1360 can be configured to control which in which the imaging system 1300 determines the location of a sample within a slide, and can be used as an input to the scan position determination section 1330.

The various sections of the imaging system 1300 are shown connected by a physical bus. Other kinds of interconnections are also permitted. It is permitted to divide up the imaging system 1300 into multiple physical sections that are separate from one another, although the various components are shown together. The various sections can be implemented in hardware or in software and hardware combined.

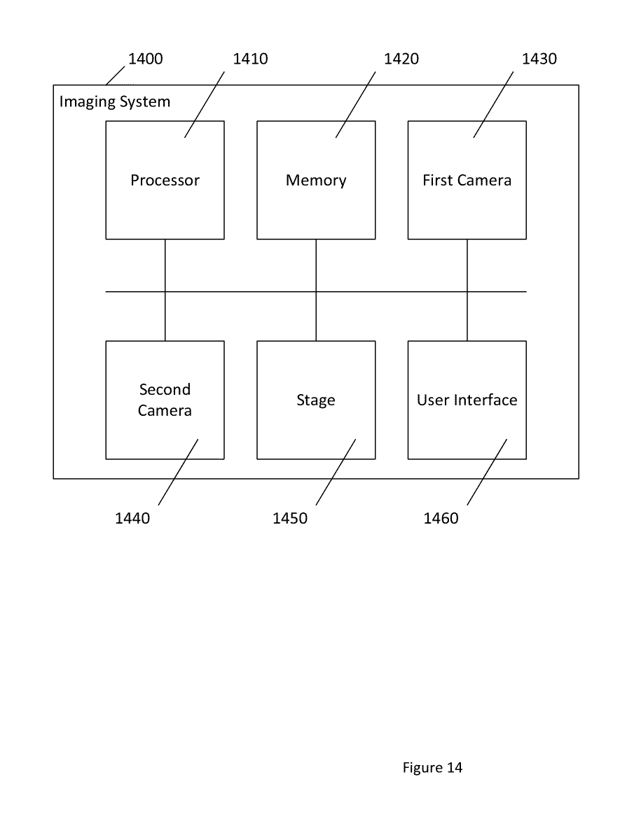

FIG. 14 illustrates an imaging system according to certain embodiments. As shown in FIG. 14, an imaging system 1400 can include at least one processor 1410 and memory 1420, which can include computer program instructions. The memory 1420 can be a non-transitory computer-readable medium. The imaging system 1400 can also include a first camera 1430, which may be a low resolution camera, and a second camera 1440, which may be a high resolution camera.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

### Glossary of Abbreviations/Terms

AFA Active Focus Area

Active Focus Area can refer to the area within a camera FOV where the autofocus hardware will evaluate the image information for focus measurement.

Blob can refer to a group/region of pixels in an image.

Cover Glass or Cover Slip can refer to a thin flat piece of transparent material; cover slips can be made of glass and put on a slide with mounting medium.

CCD Charge Coupled Device

FOV Field Of View

GSI Global Slide Image

Global Slide Image can refer to an image that a CCD video camera with appropriate optics is capable of acquiring a full slide in one image.

MB Mega Bytes

Slide can refer to a thin flat piece of glass used to hold objects (samples) for examination under a microscope.

Strip can refer to a slice of the camera image near the image border that is used for stitching to the neighboring image.

We claim:

1. A method, comprising:
obtaining, by a machine, a high level image of a sample;
determining, by the machine, whether a plurality of auto-focus areas of a plurality of fields of view are aligned with a portion of the sample; and
obtaining, by the machine, a low level image of the sample when the plurality of auto-focus areas are aligned.

2. The method of claim 1, further comprising:
shifting, by the machine, at least one of the plurality of fields of view by a shift amount, wherein the shift amount is configured to align an auto-focus area of the at least one of the plurality of fields of view with a part of the sample.

3. The method of claim 1, further comprising:
determining, for each for field of view, whether the field of view includes at least a part of the sample;
determining, for each field of view that includes at least a part of the sample, whether the sample is within an auto-focus area; and
shifting each field of view that both includes at least a part of the sample and does not include the sample within the auto-focus area.

4. The method of claim 1, further comprising:
determining an improved focus position for at least one of the plurality of fields of view; and
shifting the at least one of the plurality of fields of view to the improved focus position.

5. The method of claim 1, further comprising:
shifting at least one of the plurality of fields of view a plurality of times; and
combining a plurality of shifted versions of the at least one of the plurality of fields of view to serve as the at least one of the plurality of fields of view.

6. The method of claim 1, further comprising:
shifting at least one of the plurality of fields of view; and
composing a field of view from the shifted at least one of the plurality of fields of view and a corresponding unshifted field of view.

7. The method of claim 6, wherein composing comprises preferring the shifted version of the at least one of the plurality of views to the unshifted version of the at least one of the plurality of views when there is overlap between the shifted version of the at least one of the plurality of views to the unshifted version of the at least one of the plurality of views.

8. The method of claim 1, further comprising:
comparing the high level image of the sample to a high level image of a blank slide; and
determining a scanning procedure based on a comparison between the high level image of the sample and the high level image of the blank slide.

9. The method of claim 8, wherein the high level image of the blank slide comprises an average of a plurality of blank slide images.

10. The method of claim 1, further comprising:
determining a point on a slide that does not contain a sample or a cover slip;
normalizing between the high level image and a blank high level image based on the determined point; and
identifying a location of the sample based on the normalizing.

11. An apparatus, comprising:
a high level image source configured to provide a high level image of a sample;
a scan position determination section configured to determine whether a plurality of auto-focus areas of a plurality of fields of view are aligned with a portion of the sample; and
an image capture section configured to obtain a low level image of the sample when the plurality of auto-focus areas are aligned.

12. The apparatus of claim 10, wherein the scan position determination section is further configured to shift at least one of the plurality of fields of view by a shift amount, wherein the shift amount is configured to align an auto-focus area of the at least one of the plurality of fields of view with a part of the sample.

13. The apparatus of claim 10, wherein the scan position determination section is further configured to determine, for each for field of view, whether the field of view includes at least a part of the sample, to determine, for each field of view that includes at least a part of the sample, whether the sample is within an auto-focus area, and to shift each field of view that both includes at least a part of the sample and does not include the sample within the auto-focus area.

14. The apparatus of claim 10, wherein the scan position determination section is further configured to determine an improved focus position for at least one of the plurality of fields of view and to shift the at least one of the plurality of fields of view to the improved focus position.

15. The apparatus of claim 10, wherein the scan position determination section is further configured to shift at least one of the plurality of fields of view a plurality of times and to combine a plurality of shifted versions of the at least one of the plurality of fields of view to serve as the at least one of the plurality of fields of view.

16. The apparatus of claim 10, wherein the scan position determination section is further configured to shift at least one of the plurality of fields of view and to compose a field of view from the shifted at least one of the plurality of fields of view and a corresponding unshifted field of view.

17. The apparatus of claim 6, wherein the scan position determination section is further configured to prefer the shifted version of the at least one of the plurality of views to the unshifted version of the at least one of the plurality of views when there is overlap between the shifted version of the at least one of the plurality of views to the unshifted version of the at least one of the plurality of views.

18. The apparatus of claim 10, wherein the scan position determination section is further configured to compare the high level image of the sample to a high level image of a blank slide and to determine a scanning procedure based on a comparison between the high level image of the sample and the high level image of the blank slide.

19. The apparatus of claim 8, wherein the high level image of the blank slide comprises an average of a plurality of blank slide images.

20. The apparatus of claim 10, further comprising:
a threshold adjustment section configured to determine a point on a slide that does not contain a sample or a cover slip, to normalizing between the high level image and a blank high level image based on the determined point, and to identify a location of the sample based on the normalizing.

21. An apparatus, comprising:
high level means for obtaining a high level image of a sample;
determining means for determining whether a plurality of auto-focus areas of a plurality of fields of view are aligned with a portion of the sample; and
low level means for obtaining a low level image of the sample when the plurality of auto-focus areas are aligned.
